(19) United States
(12) Patent Application Publication
(10) Pub. No.: US 2008/0195395 A1
(43) Pub. Date: Aug. 14, 2008

(54) SYSTEM AND METHOD FOR TELEPHONIC VOICE AND SPEECH AUTHENTICATION

(76) Inventors: Jonghae Kim, Fishkill, NY (US); Moon J. Kim, Wappingers Falls, NY (US); Eric T. C. Yee, Los Angeles, CA (US)

Correspondence Address: HOFFMAN WARNICK LLC, 75 STATE ST, 14TH FLOOR, ALBANY, NY, 12207, US

(21) Appl. No.: 11/672,669

(22) Filed: Feb. 8, 2007

(51) Int. Cl. H04M 1/64; G10L 21/00

(52) U.S. Cl. 704/273; 379/88.02; 704/E17.003

(57) ABSTRACT

A telephonic authentication system, method and program product. An authentication system is provided for authenticating a user of a telephonic device that includes a setup system for capturing and storing an authentic user speech pattern sample; a comparison system that compares the authentic user speech pattern sample with an inputted speech pattern sample and generates a comparison result; and a control system for controlling access to the telephonic device. The control system analyzes the comparison result for an initial inputted speech pattern sample received when a telephone call is initiated and periodically analyzes comparison results for ongoing inputted speech pattern samples received during the telephone call.

### TECHNICAL FIELD OF THE INVENTION

The present invention relates generally to authenticating a person's voice and speech for accessing a device, and more specifically relates to a continuous voice and speech authentication system and method for telephonic devices.

### BACKGROUND OF THE INVENTION

As new telephony technologies continue to emerge, the ability to authenticate users will become more and more important. For instance, as wireless devices become smaller, they become much easier to steal, misplace or lose. If such devices can only be utilized by authorized users, the owners or service providers of the devices need not be concerned about unauthorized use. In addition to the actual devices themselves, the information being transmitted is also susceptible to unauthorized use. Accordingly, systems are required to ensure that an individual receiving information over a telephone network is authorized to receive it.

Numerous technologies exist for utilizing voice recognition to authenticate users. For instance, U.S. Pat. No. 6,393,305 B1, “Secure Wireless Communication User Identification by Voice Recognition,” issued to Ulvinen et al., on May 21, 2002, which is hereby incorporated by reference, discloses a method of authenticating a user of a wireless device using voice recognition. Similarly, U.S. Pat. No. 5,499,288, “Simultaneous Voice Recognition and Verification to Allow Access to Telephone Network Services,” issued to Hunt et al., on Mar. 12, 1996, which is hereby incorporated by reference, discloses a voice recognition system for enabling access to a network by entering a spoken password.

While such prior art references address the need for authenticating users of telephonic systems using voice recognition, more robust solutions may be required before providing access to a device. Accordingly, there exists a need in the art to overcome the deficiencies and limitations described hereinabove.

### SUMMARY OF THE INVENTION

The present invention addresses the above-mentioned problems, as well as others, by providing a voice and speech pattern authentication system that continuously analyzes both voice and speech pattern samples for authenticating users of a device. In a first aspect, the invention provides authentication system for authenticating a user of a telephonic device, comprising: a setup system for capturing and storing an authentic user speech pattern sample; a comparison system that compares the authentic user speech pattern sample with an inputted speech pattern sample and generates a comparison result; and a control system for controlling access to the telephonic device, wherein the control system: analyzes the comparison result for an initial inputted speech pattern sample received when a telephone call is initiated; and periodically analyzes comparison results for ongoing inputted speech pattern samples received during the telephone call.

In a second aspect, the invention provides a method for authenticating a plurality of users accessing a conference call, comprising: capturing and storing an authentic speech pattern sample for each user; initiating access of a joining user to the conference call; comparing an initial inputted speech pattern sample of the joining user with the authentic speech pattern samples and generating a compare result; deciding whether to allow access to the conference call based on the compare result for the joining user; periodically comparing ongoing inputted speech pattern samples for all joined users obtained during the conference call with the authentic speech pattern samples to generate a set of periodic compare results; and deciding whether to terminate access to the conference call for any of the joined users based on the periodic compare results.

In a third aspect, the invention provides a program product stored on a computer readable medium, which when executed, authenticates a user of a device, comprising: program code configured for capturing and storing an authentic user speech pattern sample and voice sample; program code configured for comparing the authentic user speech pattern sample and voice sample with an inputted speech pattern sample and inputted voice sample respectively, and for generating a comparison result; and program code configured for controlling access to the device by analyzing the comparison result for an initial inputted speech pattern sample and voice sample, and by periodically analyzing comparison results for ongoing inputted speech pattern samples and voice samples.

In a fourth aspect, the invention provides a method for deploying an authentication system for authenticating a user of a telephonic device, comprising: providing a computer infrastructure being operable to: capture and store an authentic user speech pattern sample; compare the authentic user speech pattern sample with an inputted speech pattern sample and generate a comparison result; and control access to the telephonic device, including: analyzing the comparison result for an initial inputted speech pattern sample received when a telephone call is initiated; and periodically analyzing comparison results for ongoing inputted speech pattern samples received during the telephone call.

### BRIEF DESCRIPTION OF THE DRAWINGS

These and other features of this invention will be more readily understood from the following detailed description of the various aspects of the invention taken in conjunction with the accompanying drawings in which:

FIG. 1 depicts a telephone system having an authentication system in accordance with an embodiment of the present invention.

FIG. 2 depicts a flow diagram for authenticating conference call users in accordance with an embodiment of the present invention.

FIG. 3 depicts a conference system having an interactive collaboration system in accordance with an embodiment of the present invention.

### DETAILED DESCRIPTION OF THE INVENTION

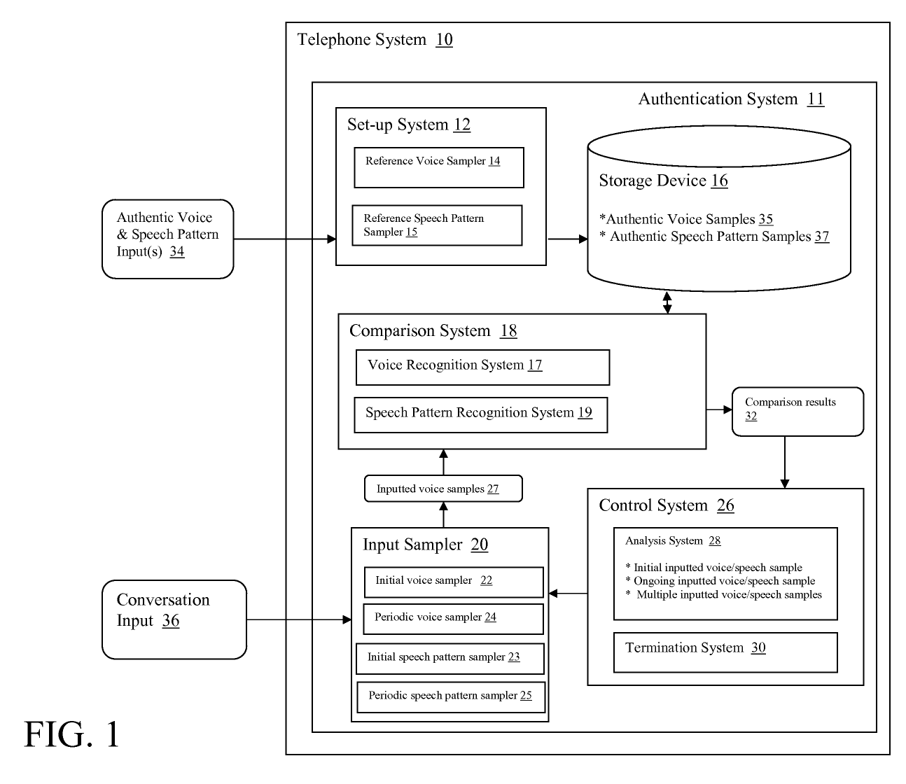

Referring now to the drawings, FIG. 1 depicts a telephone system 10 having an authentication system 11 for authenticating users of telephone system 10. Telephone system 10 may comprise any type of telephonic device through which voice information can be communicated, including, e.g., a wireless or cellular phone, a satellite phone, a multi-user phone system such as a company-based phone system, a conference call system, a land-line based telephone, an internet telephone, a network, Voice over IP system, etc. Note that while the invention is described herein with reference to a telephone system 10, the authentication features and concepts described herein could be embodied in any voice processing system. For instance, the authentication system 11 of the present invention could be embedded in any device in which authentication was required.

U.S. Patent Application Publication No. US 2005/0063522 A1, filed on Sep. 18, 2003, entitled, SYSTEM AND METHOD FOR TELEPHONIC VOICE AUTHENTICATION, which is hereby incorporated by reference, discloses a process for verifying a speaker using voice recognition. Voice recognition or voice verification is a process wherein a stored voice signature is compared to a stored voice input to authenticate a user. The voice signature essentially comprises frequency and amplitude features associated with a user's voice, regardless of the actual words being uttered. Voice verification, also known as speaker recognition, is thus a process that attempts to identify the person speaking, as opposed to what is being said.

The present invention provides a further embodiment wherein speech pattern recognition is utilized alone or in conjunction with voice verification to identify the speaker. Speech pattern recognition is a process in which stored speech patterns are compared to a speech pattern input to authenticate a user. Every human being has unique speech patterns, i.e., a distinctive manner of oral expression, that may include, e.g., phonetic duration, the duration between pauses, pitch, pause proportion, articulation rate, fluent speech rate, mean sentence length, stuttering, etc. Speech pattern recognition thus comprises a process of converting speech signals, such as words, pauses, syllables, volume, pitch, etc., to a sequence of information. For instance, the sequence of information may include an average time between pauses and an articulation rate. From the sequence of information, analysis (e.g., timing characteristics, statistics, fuzzy logic, etc.) can be utilized to compare recognized input speech patterns with known speech patterns that are associated with one or more users.

### Set-Up

As an initial step, authentication system 11 must first store one or more authentic voice samples 35 and authentic speech pattern samples 37 that can later be used as a reference to determine authenticity of the user. In the illustrative embodiment of FIG. 1, telephone system 10 includes a set-up system 12 having a reference voice sampler 14 and a reference speech pattern sampler 15 for capturing and sampling authentic voice and speech pattern inputs 34 for each authorized user of the telephone system 10. Authentic voice samples 35 and authentic speech pattern samples 37 are then stored in storage device 16. In an illustrative embodiment involving a cellular phone, authentic voice samples 35 and authentic speech pattern samples 37 can be captured and stored by an authorized user by, e.g., speaking a phrase or sentence into the receiver during a set-up procedure. The digital signature (i.e., voice) and speech pattern information of each authorized user can then be stored in the existing hardware of the cell phone. In another embodiment involving a multi-user phone system, authentic voice samples 35 and authentic speech pattern samples 37 for each authorized user can be stored in a central location or server utilized by the phone system (e.g., similar to a voice mail system). Obviously, any method for capturing and storing authentic samples 35, 37 could be utilized with departing from the scope of the invention.

Once the set-up is complete and authentic voice samples 35 and authentic speech pattern samples 37 are stored for each authorized user, any individual, or group attempting to utilize the telephone system 10 can be authenticated. If authentication fails, access to telephone system 10 can be denied or terminated, e.g., by denying access to a feature, by terminating the call, removing the individual from a conference call, etc.

### Authentication

In order to authenticate users, authentication system 11 includes an input sampler 20 for receiving and sampling conversation input 36; a comparison system 18 for comparing conversation input samples with authentic voice and speech pattern samples 35, 37; and a control system 26 for analyzing comparison results 32 from comparison system 18.

Input sampler 20 may include: (1) an initial voice sampler 22 for sampling initial voice data from a user; (2) a periodic voice sampler 24 for sampling ongoing voice data from the user; (3) an initial speech pattern sampler 23 for sampling initial speech patterns from a user; and (4) a periodic speech pattern sampler 25 for sampling ongoing speech patterns from a user. The initial voice and speech patterns can comprise any initial speech input, such as the first few words spoken by the user, or a code word or phrase spoken by the user. Ongoing voice and speech patterns generally comprise conversation spoken by the user during the lifetime of the call. Periodic samples may be collected at any interval, or in any manner, e.g., every N seconds, each time the user speaks, etc.

After inputted voice samples 27 are collected (either voice or speech patterns), they are passed to comparison system 18. Generally, each voice has its own unique signature measurable in frequency and amplitude. Voice verification is a fairly well developed field, and techniques for comparing signatures are known in the art. Similarly, each individual has his or her own unique speech patterns, which can be captured and analyzed in any known manner. Comparison system 18 can utilize any known or later developed mechanism, system or algorithm for comparing: (a) the input voice samples of the user with the authentic voice samples 35 saved in storage device 16; and/or the input speech pattern samples of the user with the authentic speech pattern samples 37 saved in storage device 16.

In this illustrative embodiment, comparison system 18 generates comparison results 32 for each compare. Comparison results 32 can comprise any type of information that reflects the analytical results of comparing two voice samples. Possible result formats may include a binary outcome such as “match” or “no-match”; a raw score indicating a probability of a match, such as “70% match”; an error condition, such as “invalid sample”; etc.

Comparison results 32 are forwarded to control system 26. Control system 26 includes an analysis system 28 that examines the comparison results 32 and either allows the call to proceed or terminates the call (or denies access to the call) using termination system 30. A feature of this embodiment is the fact that authentication of the user is continuous. Specifically, because the control system 26 receives ongoing or periodic comparison results 32 for the user, the control system 26 is able to terminate access to the system 10 at any time during the conversation. Thus, while an unauthorized user may be able to trick the system to gain initial access, ongoing access can be terminated at any time during the call if one of the ongoing inputted voice samples fails to match one of the authentic voice samples 35, or if the ongoing inputted speech pattern samples fails to match one of the authentic speech pattern samples 37.

Analysis system 28 may include various modules for analyzing or responding to comparison results 32. For instance, in the case of an initial inputted sample, the analysis system 28 may cause an additional sample to be collected and analyzed in the event of a “no-match” situation. Alternatively, analysis system 28 may simply cause access to the telephone system 10 to be denied.

In the case of ongoing inputted samples, analysis system 28 may collect and analyze multiple, or a series of, comparison results 32. Thus, the analysis system 28 can achieve a much higher level of confidence in authenticating a user. For instance, analysis system 28 could average probability scores for a set of comparison results 32. The average could then be compared to a threshold value to determine whether or not to terminate access. Moreover, analysis system 28 could weigh results from speech pattern comparisons differently than voice comparisons.

For example, assume an average probability score of at least 0.75 is required to maintain access to telephone system 10, and voice system 18 generated a set of comparison results 32 for five sequential inputted voice samples as follow: V1=0.7, V2=0.6, V3=0.9, V4=0.9, and V5=0.9; and generated a set of comparison results 32 for five sequential inputted speech pattern samples as follow: S1=0.8, S2=0.8, S3=0.9, S4=0.7, and S5=0.2. The average value for the voice comparisons would be 0.8, while the average value for the speech pattern comparisons would 0.7. Assuming analysis system 28 weighed the speech pattern comparisons twice as much as the voice comparisons, the overall result would be ((2*0.7)+0.8)/3, which would be 0.73, which would not pass the threshold of 0.75, indicating a “no-match” situation. Note that if both comparisons were weighed evenly, a “match” situation would result. It should be recognized that any algorithm or system for analyzing a set or series of comparison results could be utilized without departing from the scope of the invention. Moreover, it should be understood that authentication system 11 could be implemented using only speech recognition.

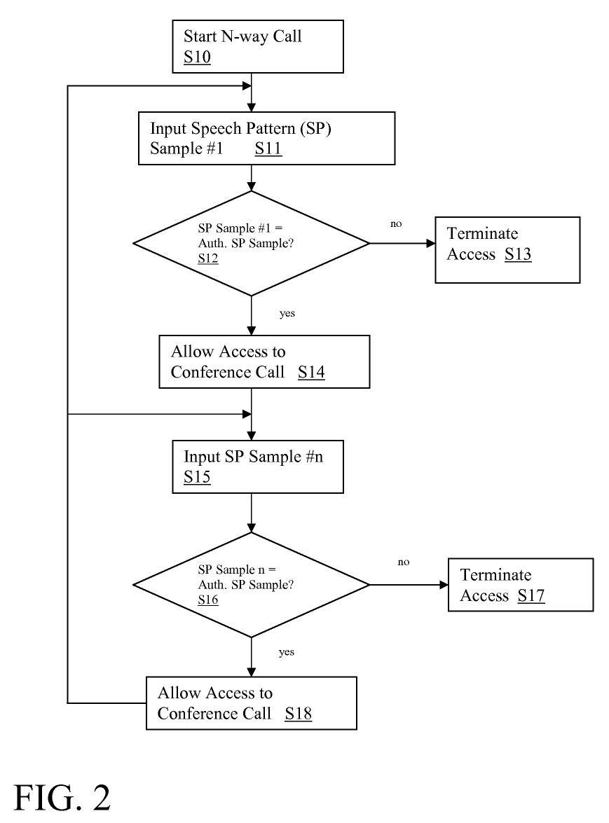

FIG. 2 depicts a flow diagram for a method of making an N-way conference call on a phone system utilizing the principles of the present invention. It is assumed that the phone system has already been through the set-up procedure and each of N authorized speech pattern samples have been stored. At step S10, the N-way call is started, and an input speech pattern sample #1 for the first participant is captured at step S11. At step S12, a test occurs to determine if input speech pattern sample #1 matches one of the authorized speech pattern samples. If no match is found, access for the first participant is terminated at step S13. If a match is found, the first participant is allowed access to the conference call at step S14.

Next, at step S15, an input speech pattern sample #n is captured for the nth participant. At step S16, a test occurs to determine if input speech pattern sample #n matches one of the authorized speech pattern samples. If no match is found, access for the nth participant is terminated at step S17. If a match is found, the nth participant is allowed access to the conference call at step S18. Subsequently, the logic continuously repeats for each of the n participants to ensure that each is an authorized participant throughout the course of the conference call, thus providing continuous testing throughout the conference call.

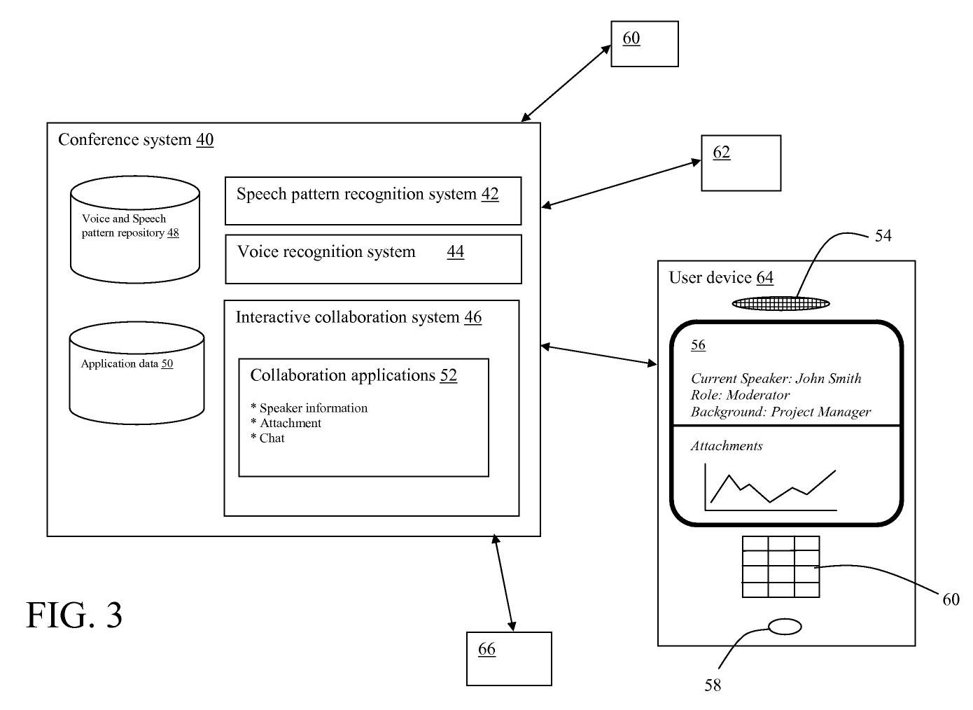

FIG. 3 depicts an illustrative embodiment of a conference system 40 that allows multiple user devices 60, 62, 64, 66 to participate in a conference call. In addition to including a speech pattern recognition system 42 and/or a voice recognition system 44, conference system 40 includes an interactive collaboration system 46 that provides one or more collaboration applications 52 for providing an enhanced conference call. Namely, interactive collaboration system 46 provides a platform through which information and functionality is shared among user devices 60, 62, 64, 66 based on a recognition of who the current speaker is.

As the various users speak during the conference call, speech pattern recognition system 42 and/or voice recognition system 44 can identify the speaker based on information stored in voice and speech pattern repository 48, e.g., using techniques described above. Once the speaker is identified, interactive collaboration system 46 can provide some enhanced collaboration feature to user devices 60, 62, 64, 66. For example, user device 64 (shown in detail) depicts an illustrate phone system that includes a speaker 54, microphone 58 and key pad 60. In addition, user device 64 includes a screen display 56 capable of receiving and displaying information from interactive collaboration system 46 relevant to the conference call. In this case, screen display 56 includes an upper window that provides information about the current speaker, and a lower window that provides an electronic whiteboard, where slides, attachments or other shared information can be displayed.

The type of information provided by interactive collaboration system 46 is based on the type of collaboration applications 52 being utilized during the conference call. Illustrative examples of collaboration applications 52 include: sharing information based on the identity of the speaker(s); providing attachments that are relevant to the speaker, or are relevant to what the speaker is discussing (e.g., as determined by speech pattern recognition system); providing a chat window for users, etc. Relevant information, such as speaker information, attachments, etc., may be stored in application data 50.

As noted above, the features of the present invention may be implemented in any type of device, and is not necessarily limited to telephony applications. For example, the authentication system 11 described above (FIG. 1) could be integrated within a user device, such as a laptop, smart phone, or any other smart technology, to serve as an authentication device. Authentication can then integrate or relate existing applications pertaining to the user's preference. For example, in a smart car implementation, not only could the authentication system 11 provide an additional security feature of authenticating the driver before the car is enabled, but could also be used to control the settings, such as air conditioning settings, radio settings, etc.

For smart homes or appliances, the authentication system 11 provides security features to authenticate the home owners. In addition, home environment settings such as lighting, temperature settings, TV channels, etc., could be controlled by the user's voice and speech patterns.

It is understood that the systems, functions, mechanisms, methods, and modules described herein can be implemented in hardware, software, or a combination of hardware and software. They may be implemented by any type of computer system or other apparatus adapted for carrying out the methods described herein. A typical combination of hardware and software could be a general-purpose computer system with a computer program that, when loaded and executed, controls the computer system such that it carries out the methods described herein. Alternatively, a specific use computer, containing specialized hardware for carrying out one or more of the functional tasks of the invention could be utilized. The present invention can also be embedded in a computer program product, which comprises all the features enabling the implementation of the methods and functions described herein, and which—when loaded in a computer system—is able to carry out these methods and functions. Computer program, software program, program, program product, or software, in the present context mean any expression, in any language, code or notation, of a set of instructions intended to cause a system having an information processing capability to perform a particular function either directly or after either or both of the following: (a) conversion to another language, code or notation; and/or (b) reproduction in a different material form.

The foregoing description of the preferred embodiments of the invention has been presented for purposes of illustration and description. They are not intended to be exhaustive or to limit the invention to the precise form disclosed, and obviously many modifications and variations are possible in light of the above teachings. Such modifications and variations that are apparent to a person skilled in the art are intended to be included within the scope of this invention as defined by the accompanying claims.

What is claimed is:

1. An authentication system for authenticating a user of a telephonic device, comprising:
a setup system for capturing and storing an authentic user speech pattern sample;
a comparison system that compares the authentic user speech pattern sample with an inputted speech pattern sample and generates a comparison result; and
a control system for controlling access to the telephonic device, wherein the control system:
analyzes the comparison result for an initial inputted speech pattern sample received when a telephone call is initiated; and
periodically analyzes comparison results for ongoing inputted speech pattern samples received during the telephone call.

2. The authentication system of claim 1, wherein the control system terminates the telephone call if the authentic user speech pattern sample does not match the initial inputted speech pattern sample.

3. The authentication system of claim 2, wherein the control system terminates the telephone call if the authentic user speech pattern sample does not match an ongoing inputted speech pattern sample.

4. The authentication system of claim 1, wherein:
the setup system is configured for capturing and storing an authentic user voice sample;
the comparison system is configured for comparing the authentic user voice sample with an inputted voice sample and generating a comparison result; and
the control system:
analyzes the comparison result for an initial inputted voice sample received when a telephone call is initiated; and
periodically analyzes comparison results for ongoing inputted voice samples received during the telephone call.

5. The authentication system of claim 4, wherein the telephonic device comprises a system that provides access to a conference call.

6. The authentication system of claim 1, wherein the telephonic device includes an interactive collaboration system that shares data amongst a plurality of devices participating in a call in response to a recognized speech pattern.

7. The authentication system of claim 6, wherein the interactive collaboration system shares data selected from the group consisting of: speaker information, attachments, and chat.

8. A method for authenticating a plurality of users accessing a conference call, comprising:
capturing and storing an authentic speech pattern sample for each user;
initiating access of a joining user to the conference call;
comparing an initial inputted speech pattern sample of the joining user with the authentic speech pattern samples and generating a compare result;
deciding whether to allow access to the conference call based on the compare result for the joining user;
periodically comparing ongoing inputted speech pattern samples for all joined users obtained during the conference call with the authentic speech pattern samples to generate a set of periodic compare results; and
deciding whether to terminate access to the conference call for any of the joined users based on the periodic compare results.

9. The method of claim 8, wherein deciding whether to allow access to the conference call based on the compare result for the initial inputted speech pattern sample includes:
denying access to the conference call if the initial inputted speech pattern sample does not match one of the authentic speech pattern samples.

10. The method of claim 9, wherein deciding whether to terminate access to the conference call based on the periodic compare for any joined users includes:
terminating the conference call for a joined user if one of the ongoing inputted speech pattern samples of the joined user does not match one of the authentic speech pattern samples.

11. The method of claim 8, further comprising:
capturing and storing an authentic voice sample for each user;
comparing an initial inputted voice sample of the joining user with the authentic voice samples and generating a second compare result;
deciding whether to allow access to the conference call based on the second compare result for the joining user;
periodically comparing ongoing inputted voice samples for all joined users obtained during the conference call with the authentic voice samples to generate a second set of periodic compare results; and
deciding whether to terminate access to the conference call for any of the joined users based on the second set of periodic compare results.

12. The method of claim 11, wherein deciding whether to terminate access to the conference call for any of the joined users is based on weighted average of the first and second sets of periodic compare results.

13. A program product stored on a computer readable medium, which when executed, authenticates a user of a device, comprising:
program code configured for capturing and storing an authentic user speech pattern sample and voice sample;
program code configured for comparing the authentic user speech pattern sample and voice sample with an inputted speech pattern sample and inputted voice sample respectively, and for generating a comparison result; and
program code configured for controlling access to the device by analyzing the comparison result for an initial inputted speech pattern sample and voice sample, and by periodically analyzing comparison results for ongoing inputted speech pattern samples and voice samples.

14. The program product of claim 13, further comprising program code configured for providing a collaborative interface through which information can be shared amongst a plurality of devices in response to inputted speech pattern samples and inputted voice samples.

15. The program product of claim 14, wherein the information shared amongst the plurality of devices is selected from the group consisting of: speaker information, attachments, and chat.

16. The program product of claim 13, wherein the inputted speech pattern sample comprises a distinctive manner of oral expression, having a characteristic selected from the group consisting of: phonetic duration, the duration between pauses, pitch, pause proportion, articulation rate, fluent speech rate, mean sentence length, and stuttering.

17. The program product of claim 16, wherein the inputted voice sample comprises a measure of frequency and amplitude.

18. The program product of claim 13, wherein the device comprises a telephone and access is terminated if the authentic user speech pattern sample does not match the initial inputted speech pattern sample.

19. The program product of claim 18, wherein the device terminates a telephone call if the authentic user speech pattern sample does not match an ongoing inputted speech pattern sample.

20. The program product of claim 13, wherein authentication of a user is based on a weighted average of a first compare result for a set of speech pattern samples and a second set of compare results for voice samples.

21. A method for deploying an authentication system for authenticating a user of a telephonic device, comprising:
providing a computer infrastructure being operable to:
capture and store an authentic user speech pattern sample;
compare the authentic user speech pattern sample with an inputted speech pattern sample and generate a comparison result; and
control access to the telephonic device, including:
analyzing the comparison result for an initial inputted speech pattern sample received when a telephone call is initiated; and
periodically analyzing comparison results for ongoing inputted speech pattern samples received during the telephone call.
